(19) United States
(12) Patent Application Publication
(10) Pub. No.: US 2022/0180684 A1
(43) Pub. Date: Jun. 9, 2022

(54) ACCESSING PREMISES BASED ON ANGLE OF ARRIVAL

(71) Applicant: CARRIER CORPORATION, Palm Beach Gardens, FL (US)

(72) Inventors: Santhosh Amuduri, Hyderabad, Telangana (IN); Adam Kuenzi, Salem, OR (US)

(21) Appl. No.: 17/252,655

(22) PCT Filed: Jul. 22, 2020
(86) PCT No.: PCT/IB2020/056871

§ 371 Date: Dec. 16, 2020

(30) Foreign Application Priority Data
Aug. 22, 2019 (IN) 201911033898

(51) Int. Cl. G07C 9/00; G06Q 50/12

(52) U.S. Cl. CPC G07C 9/00904; G07C 9/00182; G07C 9/00571; G06Q 50/12

(57) ABSTRACT

Aspects of the invention are directed towards an apparatus and a method for providing seamless access of a premises to a user based on an angle of arrival. One or more embodiments of the invention describe receiving advertisements from accessing devices on a user terminal and filtering of the advertisements from the accessing devices based on the angle of arrival. An accessing device which is intended for access is determined when the user terminal is directed towards the accessing device based on the filtering. The method also comprises sending an access command to the accessing device based on the determination.

### CROSS-REFERENCE TO RELATED APPLICATION

This application is a National Stage Application of PCT/IB2020/056871, filed Jul. 22, 2020, which claims priority to India Application No. 201911033898, filed Aug. 22, 2019, the disclosures of which are incorporated herein by reference in their entirety.

### TECHNICAL FIELD OF INVENTION

The present invention relates generally to access systems. More particularly, the invention relates to an apparatus and a method for providing seamless access to premises by users.

### BACKGROUND OF THE INVENTION

Travelling is very part and parcel of one's routine life these days leading to a boom in the hospitality industry. In the hospitality industry people are in a constant look out for finding ways to revolutionize travel by making people's stay experience at hotels more convenient. The hotel chains and staff strive hard to provide the state of the art facilities to their guests.

Traditionally, access rights to rooms in a hotel used to be provided by issuing keys of the locks to the guests. The keys gradually got replaced by physical cards which were slowly superseded by mobile phones and smartphones with further advancements in technology. In recent times, new system architectures have been developed that entail sending of periodic Bluetooth® advertisements from the locks of the hotel rooms to the mobile devices of the guests to guide them to nearby locks (by displaying room numbers, for example). However, the limitation posed by such system architectures is that when there are multiple locks within the range of the mobile device, each of the lock sends advertisements to the mobile device of the guests. For instance, if a guest is moving about in the hotel corridor wherein there are rooms on both the sides of the corridor, the guest receives advertisements from each of these locks in the corridor on his/her mobile device. This is because most of the locks in the corridor are likely to be in the range of the mobile device. Due to the substantial number of the advertisements, the situation gets complicated creating confusion for the guest as to which lock to open. It may even lead to inadvertent accessing of a room lock as all the locks are within the range of the mobile device. Further, the task of displaying all the lock advertisements is quite cumbersome and leads to battery consumption of the mobile device.

In view of the aforementioned problems, there is a need in the art for an efficient apparatus and a method to filter out the lock advertisements so as to prevent confusion and inconvenience of the guest. There is also a requirement to prevent unintentional and unauthorized opening of room locks for security and privacy reasons. In order to solve these problems, an apparatus and a method is disclosed.

### SUMMARY OF THE INVENTION

Various embodiments of the invention describe an apparatus and a method for filtering advertisements from accessing devices based on the angle-of-arrival and providing seamless access of a premises to a user. The invention discloses a method comprising receiving advertisements from accessing devices on a user terminal and determining an angle-of-arrival from each of the accessing devices. The method further comprises filtering of the advertisements from the accessing devices based on the angle of arrival and determining an accessing device intended for access based on the filtration. The user of the user terminal directs the user terminal towards the accessing device intended for access for the determination. The method also comprises sending an access command to the accessing device based on the determination.

In another embodiment of the invention, the method further comprises sending the access command when a signal strength between the user terminal and the accessing device is above a threshold value.

In another embodiment of the invention, the user terminal receives advertisements from multiple accessing devices through a short range communication. The advertisements are received based on a predetermined proximity of the user terminal from the accessing devices.

In yet another embodiment of the invention, the advertisements comprise displaying a unique identifier associated with each of the accessing device.

In still another embodiment of the invention, the accessing device is associated with an indicator which is activated when the user terminal sends the access command at the angle-of-arrival to the accessing device.

In an embodiment of the invention, the angle-of-arrival is measured by the user terminal on detecting the advertisement from the accessing device by two antennas of the user terminal, wherein the two antennas measure a phase difference between the signals received by the two antennas to calculate the angle-of-arrival.

In another embodiment of the invention, filtering the advertisements from accessing devices based on the angle-of-arrival comprises determining if the angle of arrival from each accessing device lies within a predetermined range.

In another different embodiment of the invention, each of the accessing device is a lock or a key box to access premises.

In yet another different embodiment of the invention, the filtration displays the advertisements of the accessing devices which are within the predetermined range of the angle-of-arrival.

In yet another embodiment of the invention, a user terminal is disclosed for filtering advertisements from accessing devices based on angle-of-arrival and providing seamless access to a premises to a user. The user terminal comprises of a communication unit to establish communication with the accessing devices. The communication unit is further configured to receive advertisements from each of the accessing devices on a user terminal. The user terminal also comprises a filtration unit for filtering the advertisements from the accessing devices based on an angle-of-arrival. The angle-of-arrival is determined based on the advertisements received by the user terminal from each of the accessing device. The user terminal further comprises a determination unit to determine an accessing device intended for access based on the filtration, wherein the user terminal is directed to the accessing device for the determination. The user terminal comprises a transmission unit to transmit an access command to the accessing device based on the determination.

In another embodiment of the invention, the user terminal further comprises sending the access command when a signal strength between the user terminal and the accessing device is above a threshold value.

In yet another embodiment of the invention, the user terminal receives advertisements from multiple accessing devices through a short range communication. The advertisements are received based on a predetermined proximity of the user terminal from the accessing devices.

In still another embodiment of the invention, the advertisements comprise displaying unique identifier associated with each of the accessing device.

In another embodiment of the invention, the accessing device is associated with an indicator which is activated when the user terminal sends the access command at the angle-of-arrival to the accessing device.

In an embodiment of the invention, the angle-of-arrival is measured by the user terminal after detecting the advertisements from each of the accessing devices by two antennas of the user terminal, wherein the two antennas measure a phase difference between the signals received by the two antennas to calculate the angle-of-arrival.

In another different embodiment of the invention, the advertisements from accessing devices are filtered based on the angle-of-arrival comprises determining if the angle-of-arrival from each accessing device lies within a predetermined range.

In still another different embodiment of the invention, each of the accessing device is a lock or a key box to access premises.

In yet another different embodiment of the invention, the filtration displays the advertisements of the accessing devices which are within the predetermined range of the angle-of-arrival.

In various other embodiments of the invention, a computer readable medium is disclosed comprising one or more processors and a memory coupled to the one or more processors. The memory stores instructions which are executed by the one or more processors configured to receive advertisements from accessing devices on a user terminal. The memory stores instructions which are executed by the one or more processors configured to direct the user terminal towards an accessing device to determine an angle-of-arrival from each of the accessing devices. The memory also stores instructions which are executed by the one or more processors configured to filter the advertisements from the accessing devices based on the angle-of-arrival and determine an accessing device intended for access based on the filtration. The user terminal is directed to the accessing device for the determination. The memory further stores instructions which are executed by the one or more processors configured to send an access command to the accessing device based on the determination.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1A is an exemplary diagram illustrating a system in accordance with an exemplary embodiment of the invention.

FIG. 1B is an exemplary diagram illustrating a mechanism to calculate angle-of arrival in accordance with an exemplary embodiment of the invention.

FIG. 2 is an exemplary diagram illustrating multiple advertisements in accordance with an exemplary embodiment of the invention.

FIG. 3 is an exemplary diagram illustrating a filtered advertisement in accordance with another exemplary embodiment of the invention.

FIG. 4 is an exemplary block diagram of different components of a user terminal according to an exemplary embodiment of the invention.

FIG. 5 is an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology with an apparatus and a method for filtering advertisements from accessing devices based on an angle-of-arrival (AoA) and providing seamless access of a premises to a user. When the user is moving in a corridor having a number of accessible rooms, the accessing devices of each of the rooms sends advertisements that are received by a user terminal through a short range communication. The user terminal determines the AoA of each advertisement received by the user terminal. Based on the AoA, the advertisements which are not relevant to the user are filtered out and the accessing device intended for access is determined to provide access of the premises to the user.

As used herein, the user may be, but is not limited to a guest, a client, a hotel staff, a janitor, a housekeeping personnel, an employee or any other such user known in the art.

As used herein, the accessing device may be, but is not limited to, a lock, a key box, a knob, a latch, a fastener or any other such device having communication capabilities well known in the art, that is able to communicate through short communication network.

As used herein, the user terminal can be any hand held device such as a mobile phone or a smartphone or a tablet or any wearable device or a personal digital assistance (PDA) or any such device known in the art with at least a display, a storage unit and network connectivity, and at least two antennas to determine AoA. As an example, the hand held device may be an Apple® tablet or smartphone, an Android® tablet or smartphone, a Windows® tablet or smartphone and/or the like having above mentioned features.

As used herein, the short range communication may include a personal area network such as a Bluetooth network, a Wi-Fi network, a near-field network, or a ZigBee network.

As used herein, the angle-of-arrival is measured at the user terminal (receiver) relative to the accessing device (transmitter) and is analyzed to determine in which direction the user terminal is directed to. It may also be referred to as the door access angle. The details of calculating the angle-of arrival are described below.

As used herein, each of the accessing devices broadcasts advertisements. The advertisements can be one or more signals including the identifiers and other information. The advertisements are also used to determine the AoA from each of the accessing devices.

As used herein, the premises may be, but not limited to, a room, an assembly hall, meeting room, conference hall, lecture room, office cabin, chamber, concert hall, auditorium, party hall or any other such premises known in the art.

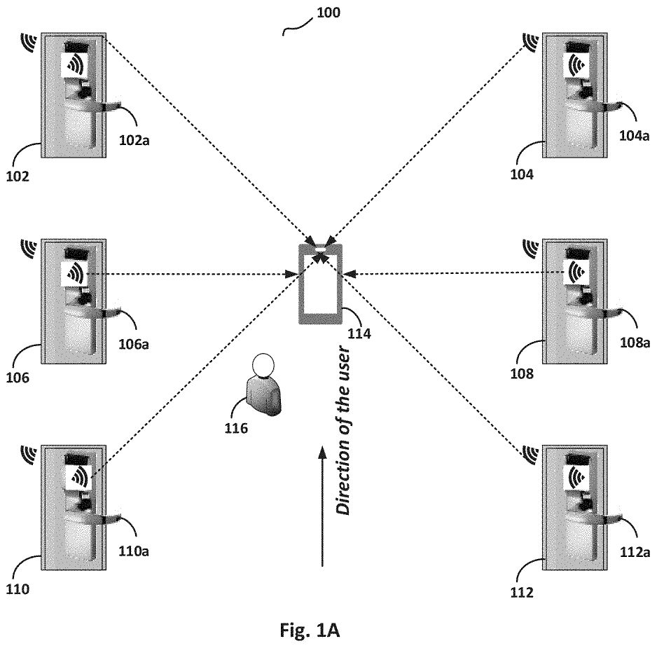

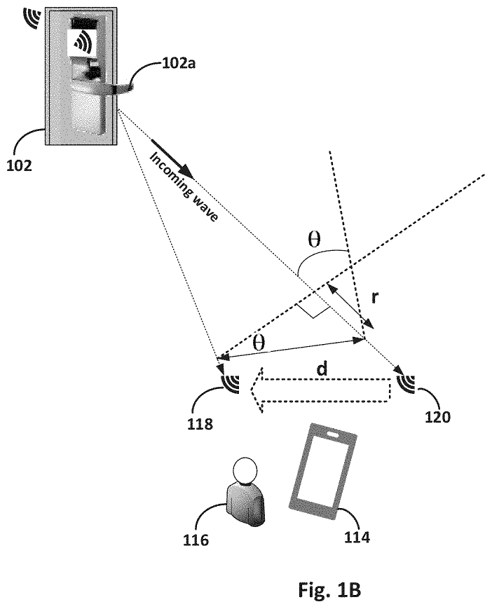

FIG. 1A depicts an exemplary system architecture 100 for providing seamless access of a premises 102/104/106/108/110/112 to a user 116 based on an angle of arrival (AoA), in accordance with an exemplary embodiment of the invention. As depicted in FIG. 1A, the accessing device 102a/104a/106a/108a/110a/112a associated with the premises 102/104/106/108/110/112 may communicate with a user terminal 114 through short range communication. In an embodiment, the accessing device 102a/104a/106a/108a/110a/112a may be a lock or a key box.

Considering an exemplary scenario, there may be multiple accessing devices 102a/104a/106a/108a/110a/112a in the vicinity of the user 116 that are within the range of the user terminal 114. Each of the accessing devices 102a/104a/106a/108a/110a/112a may have a unique identifier associated with the device. Each of the accessing device 102a/104a/106a/108a/110a/112a may continuously or periodically advertise the identifiers associated with the accessing devices 102a/104a/106a/108a/110a/112a in the form one of one or more packets. As an example, the architecture 100 having accessing devices 102a/104a/106a/108a/110a/112a may refer to a corridor with number of premises (for example, rooms) each having accessing devices 102a/104a/106a/108a/110a/112a.

The user terminal 114 may receive advertisements encoded with the identifiers associated with the accessing devices 102a/104a/106a/108a/110a/112a from each of the accessing devices 102a/104a/106a/108a/110a/112a present in proximity to the user terminal 114. As the user 116 moves through the corridor having accessing devices 102a/104a/106a/108a/110a/112a, the user terminal 114 may receive advertisements from the accessing devices 102a/104a/106a/108a/110a/112a.

The user terminal or device 114 may then measure the AoA at the user terminal 114 that acts as a receiver, relative to the accessing devices 102a/104a/106a/108a/110a/112a that act as transmitters. The AoA may be measured by the user terminal 114 after detecting the advertisements from each of the accessing devices 102a/104a/106a/108a/110a/112a by two antennas of the user terminal 114. The two antennas of the user terminal 114 measure a phase difference between the signals received by the two antennas to calculate the AoA. The AoA may be analyzed to understand in which direction the advertisements are being received relative to the user terminal 114. In essence, the AoA may be used to determine which direction the user terminal 114 is pointed or directed to. For example, an advertisement that is determined to have an AoA with advertisement from front of the device is determined to be ‘in front’ of the device. Alternatively, an advertisement that is determined to be coming from the left or right of the device 114 is determined to be ‘on the side’ or ‘behind’ of the device.

Based on the AoA, the advertisements from the accessing devices 102a/104a/106a/108a/110a/112a may be filtered out displaying only the identifiers of the premises 102/104/106/108/110/112 that may be there in front of the user 116 ignoring the premises 102/104/106/108/110/112 that are behind the user 116. Alternatively, the identifiers of those premises 102/104/106/108/110/112 may be displayed that are in synchronization with or in the direction of the user terminal 114 or that may be found to be within the predetermined range of AoA configured. The filtering of advertisements involves determining if the AoA from each of the accessing devices 102a/104a/106a/108a/110a/112a lies within a predetermined range defined with respect to the user terminal 114 and the accessing device intended to access. In an exemplary embodiment, the predefined range of AoA may be 60°±20°. In this scenario, the user 116 will be provided access to the premises 102/104/106/108/110/112 only when the AoA between the user terminal 114 and the accessing device 102a/104a/106a/108a/110a/112a lies within 60°±20°.

Based on the filtration of the advertisements from the accessing devices 102a/104a/106a/108a/110a/112a, one or more accessing devices 102a/104a/106a/108a/110a/112a that are intended for access by the user 116, may be determined. When the user 116 is in front of the accessing device 102a/104a/106a/108a/110a/112a that the user 116 intends to access, the user directs the user terminal towards the intended accessing device at a predefined AoA. The user terminal filters out the accessing device which the user intends to access. The user terminal 114 may then initiate an access command to the accessing device, for example, any one of 102a/104a/106a/108a/110a/112a to obtain access of the premises 102/104/106/108/110/112. The user terminal 114 using a sensor may detect if the user terminal is being held in hand and pointed or directed towards the accessing device 102a/104a/106a/108a/110a/112a or is kept in someone's pocket or purse and is being carried. In an embodiment, the sensor may be a gyroscope sensor. The initiation of the access command by the user terminal 114 may also require that the signal strength between the user terminal 114 and the accessing device 102a/104a/106a/108a/110a/112a is above a predefined threshold value. If the signal strength may be found to be higher or lower than the predefined threshold value, the access command may not be initiated.

The accessing device 102a/104a/106a/108a/110a/112a may then receive the access command from the user terminal 114 to activate an indicator associated with the accessing device 102a/104a/106a/108a/110a/112a and provide access to the premises 102/104/106/108/110/112 to the user 116. In an embodiment, the indicator associated with the accessing device 102a/104a/106a/108a/110a/112a may be a light emitting diode (LED), LCD display and the like.

FIG. 1B illustrates an exemplary measurement of an angle of arrival of a signal from the accessing device 102. As illustrated, the angle of arrival is calculated using two or more antennae, for example, in an embodiment an antenna 118 is positioned at one end of the mobile device 114 and an antenna 120 is positioned at another end of the mobile device 114. The distance between the two antennae 118 and 120 being attributed to the variable ‘d’. The angle of arrival of the signal from the accessing device 102 will be governed by the below equations:

$$\begin{matrix}r = \frac{λϕ}{2 π} & ( 1 ) \\ r = d sin ( θ ) & ( 2 ) \\ sin ( θ ) = \frac{r}{d} & ( 3 )\end{matrix}$$

where, Φ represents the phase shift in the signal received by the two antennae 118 and 120, and Θ is the angle of arrival of the signal from the accessing device 102.

Although FIG. 1B illustrates the calculation of the angle of arrival in two dimensions, the same principles are applicable in measurement of angle of arrival in three-dimensional space. For example, assuming the space is defined by three dimensions x, y, and z, calculation of angles of arrival with respect to xy, yz, and xz planes for an object (for example, the accessing device 102) placed in three dimensional space can be calculated as a representation of the position of the object within the three dimensional space.

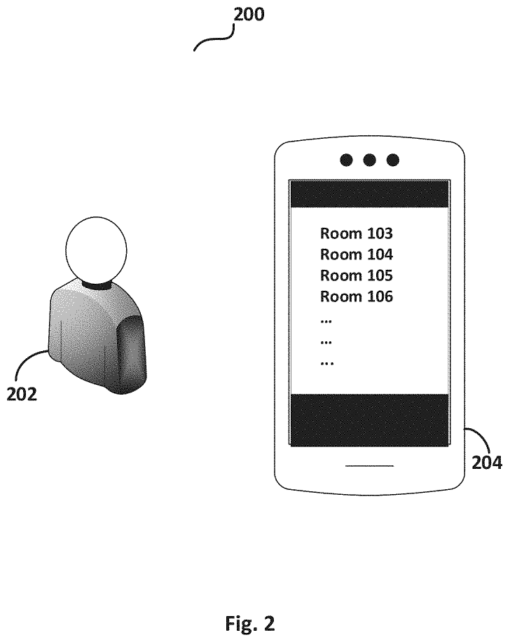

FIG. 2 depicts a user 202 with a user terminal 204 displaying multiple advertisements in accordance with an exemplary embodiment of the invention. When the user 202 is in close proximity to multiple accessing devices 102a/104a/106a/108a/110a/112a, the user terminal 204 may receive multiple advertisements transmitted by the accessing devices 102a/104a/106a/108a/110a/112a. The advertisements comprise displaying a unique identifier associated with each of the accessing device 102a/104a/106a/108a/110a/112a. As depicted in the FIG. 2, the unique identifier may be a room number.

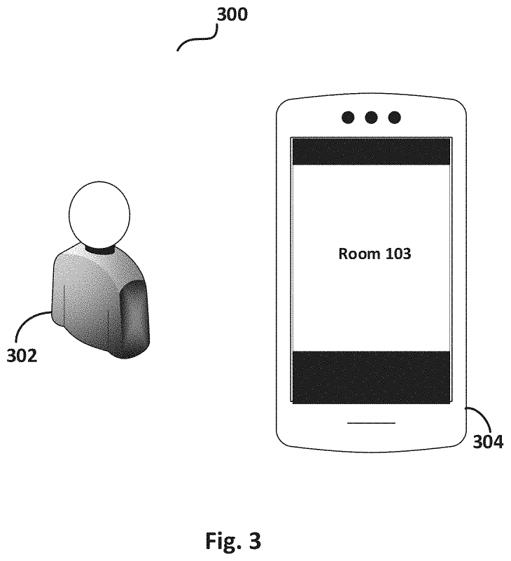

FIG. 3 illustrates an advertisement being displayed on the user terminal 304 of the user 302 received after filtering out irrelevant advertisements based on an AoA. As the user 302 passes by the accessing devices 102a/104a/106a/108a/110a/112a, the advertisements from accessing devices 102a/104a/106a/108a/110a/112a that are not within the predetermined range of the AoA may be filtered out. The advertisements are filtered out to show the one or more accessing devices 102a/104a/106a/108a/110a/112a that may be in front of the user 302 with the AoA being in the predefined range. When the user directs the user terminal towards an accessing device at a preconfigured AoA, the user terminal may filter the one or more devices to display the accessing device which is intended for access.

In an exemplary embodiment if the user rotates the user terminal around and ‘points’ it at different accessing devices, the AoA will change. This will in turn change the AoA of received advertisements, change the result of the filter, and change which accessing device is shown on the screen of the user terminal 204.

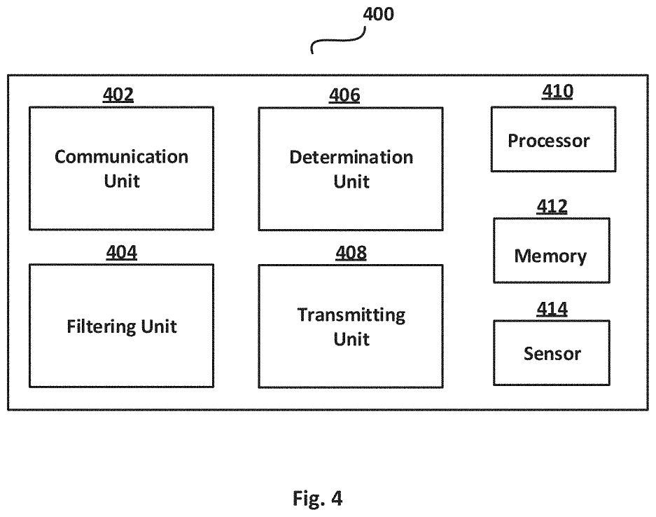

FIG. 4 depicts the exemplary block diagram of different components of a user terminal 400 according to an exemplary embodiment of the invention. The user terminal 400 comprises, but is not limited to, a communication unit 402, a filtration unit 404, a determination unit 406, a transmission unit 408, a processor 410, a memory 412 and a sensor 414. The communication unit 402 establishes communication with the accessing device 102a/104a/106a/108a/110a/112a. The communication unit 402 may be further configured to receive advertisements from the accessing devices 102a/104a/106a/108a/110a/112a on the user terminal 400. The filtration unit 404 may be configured to filter advertisements from the accessing devices 102a/104a/106a/108a/110a/112a based on the AoA. The determination unit 406 may be configured to determine one or more accessing devices 102a/104a/106a/108a/110a/112a intended for access based on the filtration of advertisements. When the user of the user terminal directs the user terminal towards an accessing device intended for access at a preconfigured AoA, the user terminal may filter out all the accessing device and display only the accessing devices intended for access based on the AoA The transmission unit 408 may be configured to transmit the access command to the accessing device based on the determination carried out by the determination unit 406. The sensor 414 may be a gyroscope sensor. The sensor 414 may detect whether the user terminal 400 is being held in hand and directed towards the accessing device 102a/104a/106a/108a/110a/112a or is being carried in the user's purse/bag or pocket. For example, the gyroscope/accelerometer can detect the direction of gravity relative to a case of the user terminal (for example, smartphone). If the user terminal is held relatively ‘flat’ with respect to the earth, then the direction of gravity is straight out the back of the phone and this can indicate how the user terminal is being held. Alternatively, if the user terminal is in a purse or handback the direction of gravity relative to the phone may be some other direction indicating it is not being held in the correct horizontal position. The communication unit 402, the filtration unit 404, the determination unit 406, the transmission unit 408, the memory 412 and the sensor 414 are communicably connected to the processor 410 for executing different tasks processed by the processor.

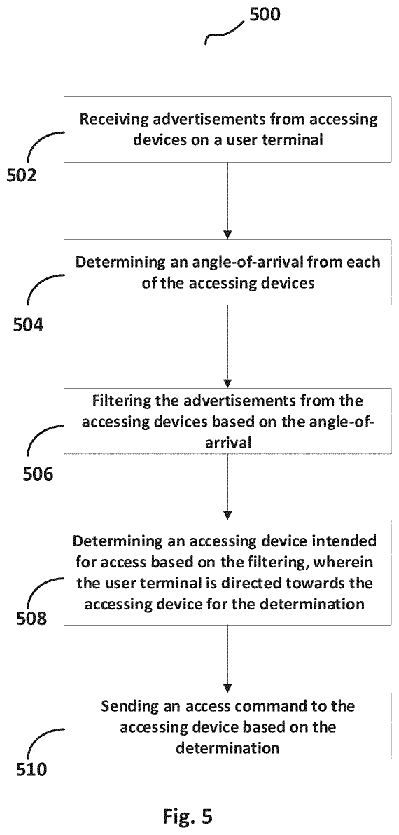

FIG. 5 depicts a flowchart illustrating a method to perform the invention according to an exemplary embodiment of the invention. The method flowchart 500 describes a method being performed for enabling the invention. The method may start at step 502. At step 502, the user terminal 114 may receive advertisements from the accessing devices 102a/104a/106a/108a/110a/112a that are within the range of the user terminal 114. At step 504, the AoA from each of the accessing devices 102a/104a/106a/108a/110a/112a is determined. At step 506, the user terminal 114 filters the advertisements received from the accessing devices 102a/104a/106a/108a/110a/112a based on the AoA. At step 508, the user terminal 114 determines an accessing device 102a/104a/106a/108a/110a/112a intended for access based on the filtering. The determination is made based on the user terminal being directed towards the accessing device.

The intent described herein may be determined automatically when: 1) The user holds the user terminal in a predetermined position to access the accessing device 2) Only one device is towards the ‘front’ of the user terminal and 3) The signal strength is over a threshold 4) the filtering has reduced and the number of accessing devices on the screen of the user terminal to one 5) A predetermined gesture over the user terminal by the user which may be detected by the gyroscope/accelerometer (i.e. phone is shook). Further, the user may tap one of the accessing device displayed on the screen of the user terminal to access the premises. At step 510, the user terminal 114 sends an access command to the accessing device 102a/104a/106a/108a/110a/112a based on the determination carried out in step 508. The method may end at step 510.

In an embodiment of the invention, the advertisements are received by the user terminal from the accessing devices when the user approaches the intended accessing device. The user terminal includes the information of the intended accessing device. Accordingly, as the advertisements are received by the user terminal from the accessing devices, the user may be directed to the intended accessing device (for example, user's room) based on the advertisements. That is, if the intended accessing device is left behind, the user terminal may direct the user (by alert, prompt on the display screen etc.) that the accessing device intended for access is left behind.

In an embodiment of the invention, if there is lock down and the accessing devices may not accept the access commands from the user terminal. At that time, a front desk associated with the premises may communicate with the user terminal. The front desk may provide a message or push notification to the user terminal over a network. The received message or the push notification may trigger the user terminal to communicate with the accessing device at a predefined angle of arrival. The angle of arrival may be used to identify the premises associated with the accessing device and automatically send the access command to the accessing device in order to unlock the accessing device for gaining access inside the premises.

The present invention is applicable to the hospitality industry, hospitals, schools, colleges, offices, banks, commercial buildings and any such premises obvious to the person skilled in the art wherein multiple accessing devices capable of sending advertisements to the user terminal may be present and the premises can be accessed based on the preconfigured angle-of-arrival.

The present invention provides for the following technical advantages over the existing methods and solutions where the user terminal receives a substantial number of advertisements from all the accessing devices present in proximity: a) filtering of advertisements based on AoA provides the user with the details of only those accessing devices that are intended for access; b) helps avoid confusion and inconvenience to the user caused by multiple advertisements; c) saves battery of the user terminal; d) helps locating an accessing device that is ‘hidden’ or ‘hard to see’; e) prevents unintended access to the premises by the user; f) provides for better security of the premises; g) helps save energy of the accessing device as the indicator is not flashed continuously but only when the user terminal is directly in front of the accessing device for accessing.

The embodiments of the invention discussed herein are exemplary and various modification and alterations to a person skilled in the art are within the scope of the invention.

Another embodiment of the invention discloses a computer readable medium comprising one or more processors and a memory coupled to the one or more processors, the memory storing instructions which are executed by the one or more processors, the one or more processors configured to receive advertisements from the accessing devices 102a/104a/106a/108a/110a/112a on the user terminal 114. The memory storing instructions which are executed by the one or more processors are also configured to filter the advertisements from the accessing devices 102a/104a/106a/108a/110a/112a based on AoA determined by the user terminal and determine the accessing device 102a/104a/106a/108a/110a/112a intended for access based on filtering. The determination is made when the user terminal is directed towards the accessing device intended for access. The memory storing instructions which are executed by the one or more processors are further configured to send the access command to the accessing device based on the determination.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving advertisements from accessing devices on a user terminal;
determining an angle-of-arrival from each of the accessing devices;
filtering the advertisements from the accessing devices based on the angle-of-arrival;
determining an accessing device intended for access based on the filtration, wherein the user terminal is directed towards the accessing device for the determination; and
sending an access command to the accessing device based on the determination.

2. The method of claim 1, further comprising sending the access command when a signal strength between the user terminal and the accessing device is above a threshold value.

3. The method of claim 1, wherein the user terminal receives advertisements from multiple accessing devices through a short-range communication, wherein the advertisements are received based on a predetermined proximity of the user terminal from the accessing devices.

4. The method of claim 1, wherein the advertisements comprise displaying unique identifier associated with each of the accessing device.

5. The method of claim 1, wherein the accessing device is associated with an indicator which is activated when the user terminal sends the access command at the angle-of-arrival to the accessing device.

6. The method of claim 1, wherein the angle-of-arrival is measured by the user terminal on detecting the advertisements from each of the accessing device using two antennas of the user terminal, wherein the two antennas measure a phase difference between the signals received by the two antennas to calculate the angle-of-arrival.

7. The method of claim 1, wherein filtering the advertisements from accessing devices based on the angle-of-arrival comprises determining if the angle-of-arrival from each accessing device lies within a predetermined range.

8. The method of claim 1, wherein each of the accessing device is a lock or a key box to access premises.

9. The method of claim 1, wherein the filtration displays the advertisements of the accessing devices which are within the predetermined range of the angle-of-arrival.

10. A user terminal comprising:
a communication unit to establish communication with accessing devices, the communication unit further configured to receive advertisements from each of the accessing devices on a user terminal;
a filtration unit for filtering the advertisements from the accessing devices based on an angle-of-arrival, wherein the angle-of-arrival is determined based on the advertisements received by the user terminal from each of the accessing device;
a determination unit to determine an accessing device intended for access based on the filtration, wherein the user terminal is directed to the accessing device for the determination; and
a transmission unit to transmit an access command to the accessing device based on the determination.

11. The user terminal of claim 10, further comprising sending the access command when a signal strength between the user terminal and the accessing devices is above a threshold value.

12. The user terminal of claim 10, wherein the user terminal receives advertisements from multiple accessing devices through a short-range communication, wherein the advertisements are received based on a predetermined proximity of the user terminal from the accessing devices.

13. The user terminal of claim 12, wherein the advertisements comprise displaying unique identifier associated with each of the accessing device.

14. The user terminal of claim 10, wherein the accessing device is associated with an indicator which is activated when the user terminal sends the access command at the angle-of-arrival to the accessing device.

15. The user terminal of claim 10, wherein the angle of arrival is measured by the user terminal after detecting the advertisements from each of the accessing devices by two antennas of the user terminal, wherein the two antennas measure a phase difference between the signals received by the two antennas to calculate the angle-of-arrival.

16. The user terminal of claim 10, wherein filtering the advertisements from accessing devices based on the angle-of-arrival comprises determining if the angle-of-arrival from each accessing device lies within a predetermined range.

17. The user terminal of claim 10, wherein each of the accessing device is a lock or a key box to access premises.

18. The user terminal of claim 10, wherein the filtration displays the advertisements of the accessing devices which are within the predetermined range of the angle-of-arrival.

19. A computer readable medium comprising one or more processors and a memory coupled to the one or more processors, memory storing instructions executed by the one or more processors, the one or more processors configured to:
receive advertisements from accessing devices on a user terminal;
determine an angle-of-arrival from each of the accessing devices;
filter the advertisements from the accessing devices based on the angle-of-arrival;
determine the accessing device intended for access based on the filtration, wherein the user terminal is directed towards the accessing device for the determination; and
send an access command to the accessing device based on the determination.

20. The computer readable medium of claim 19, wherein filtering the advertisements from accessing devices based on the angle of arrival comprises determining if the angle-of-arrival from each accessing device lies within a predetermined range.
